(19) United States
(12) Patent Application Publication
(10) Pub. No.: US 2019/0103995 A1
(43) Pub. Date: Apr. 4, 2019

(54) WIRELESS COMMUNICATION SYSTEM AND SIGNAL PROCESSING METHOD THEREOF

(71) Applicant: MStar Semiconductor, Inc., Hsinchu Hsien (TW)

(72) Inventors: Chih-Cheng KUO, Hsinchu Hsien (TW); Tai-Lai TUNG, Hsinchu Hsien (TW)

(21) Appl. No.: 15/818,994

(22) Filed: Nov. 21, 2017

(30) Foreign Application Priority Data
Sep. 29, 2017 (TW) 106133644

(51) Int. Cl. H04L 25/02; H04L 25/03

(52) U.S. Cl. CPC H04L 25/0212; H04L 25/03076

(57) ABSTRACT

A wireless communication system includes a channel estimation circuit, a shortening circuit, a time-domain decision feedback equalizer and a coefficient calculation circuit. The channel estimation circuit generates an estimated channel pulse response according to a received signal. The shortening circuit defines a shortened impulse response from the estimated channel impulse response according to a main energy distribution region of the estimated channel impulse response. The time-domain decision feedback equalizer performs time-domain equalization on the received signal, and includes a feedforward filter for filtering the received signal. The coefficient calculation circuit calculates, according to the shortened impulse response, a set of feed-forward filter coefficients to be utilized by the feedforward filter.

This application claims the benefit of Taiwan application Serial No. 106133644, filed Sep. 29, 2017, the subject matter of which is incorporated herein by reference.

### BACKGROUND OF THE INVENTION

### Field of the Invention

The invention relates in general to a wireless communication system, and more particularly, to a technology for determining filter coefficients for a time-domain decision feedback equalizer in a wireless communication system.

### Description of the Related Art

In many wireless communication systems, in order eliminate interference caused by multipath, a receiver is provided with a time-domain equalizer. For wireless communication standards, e.g., Digital Video Broadcasting-Cable (DVB-C), Advanced Television Systems Committee (ATSC), Digital Terrestrial Multimedia Broadcast (DTMB), which adopt single-carrier time-domain transmission, decision feedback is an effective and practical equalizer structure.

FIG. 1 shows a schematic diagram of a wireless receiver 100. The wireless receiver 100 includes a channel estimation circuit 110, a coefficient calculation circuit 120 and a time-domain decision feedback equalizer 130. The channel estimation circuit 110 generates an estimated channel impulse response according to a received signal entering the wireless receiver 100, and estimates a channel response of a channel through which a transmitted signal passes before the transmitted signal reaches the receiver 100. The time-domain decision feedback equalizer 130 includes a feedforward filter 130A, an adder 130B, a feedback filter 130C and a slicer 130D. The coefficient calculation circuit 120 calculates, according to the estimated channel impulse response outputted from the channel estimation circuit 110, initial values of various filter coefficients (e.g., center frequency, cut-off frequency and bandwidth) to be utilized by the feedforward filter 130A and the feedback filter 130C. The time-domain decision feedback equalizer 130 corrects the filter coefficients through iteration calculation. An output signal of the adder 130B (i.e., the equalized signal) is transmitted to a decoding circuit 140 for decoding to generate a decoded bitstream.

FIG. 2 shows a signal model corresponding to the time-domain decision feedback equalizer 130. In FIG. 2, the symbol x(n) represents an original signal outputted from the transmitting end, the symbol H(z) represents an impulse response contributed by the channel through which the original signal x(n) passes, the symbol y (n) represents a received signal fed into the channel estimation circuit 110 and the time-domain decision feedback equalizer 130, where the task of the channel estimation circuit 110 is generating an estimated value of the impulse response H(z), the symbols F(z) and B(z) respectively represent frequency responses contributed by the feedforward filter 130A and the feedback filter 130C, and the symbol δ represents a delay amount. Further, the original signal x(n−δ) is delayed by δ number of samples relative to the original signal x(n).

One method that the coefficient calculation circuit 120 uses to generate the initial values of the filter coefficients is setting a calculation target as “minimizing an expected value of a difference between an equalized signal \hat{x}(n−δ) and the original signal x(n−δ)”, with details of the deduction given below.

First of all, the equalized signal \hat{x}(n−δ) outputted by the adder 130B can be represented as:

\hat{x}(n−δ)=yₙf−\tilde{x}ₙb (1)

In equation (1), the symbol f represents a filter coefficient vector of the feedforward filter 130A and has a length L, the symbol b represents a filter coefficient vector of the feedback filter 130C and has a length M, the symbol yₙ represents a series of successive received signal samples [y(n)y(n−1) . . . y(n−(L−2))y(n−(L−1))], and the symbol \tilde{x}ₙ represents a series of successive sliced signal samples [\tilde{x}(n−δ−1)\tilde{x}(n−δ−2) . . . \tilde{x}(n−δ−(M −1)\tilde{x}(n−δ−M)].

It is seen from FIG. 2 that, the received signal yₙ may be represented as a result of the original signal x(n) with channel effect:

yₙ=xₙH+vₙ (2)

In equation (2), the symbol xₙ represents a series of successive original signal samples [x(n)x(n−1) . . . x(n−(N +L−2))], and the symbol H represents a matrix formed by estimated channel impulse responses h:

$$[ \begin{matrix}h ( 0 ) & & & & & \\ h ( 1 ) & h ( 0 ) & & & & \\ h ( 2 ) & h ( 1 ) & h ( 0 ) & & & \\ ⋮ & ⋮ & ⋮ & & & \\ h ( L - 1 ) & h ( L - 2 ) & h ( L - 3 ) & ⋯ & h ( 0 ) & \\ ⋮ & ⋮ & ⋮ & ⋯ & ⋮ & h ( 9 ) \\ h ( L - 1 ) & h ( N - 2 ) & h ( N - 3 ) & ⋯ & h ( N - L ) & ⋮ \\ & h ( N - 1 ) & h ( N - 2 ) & ⋯ & h ( N - ( L - 1 ) ) & h ( N - 1 ) \\ & & h ( N - 1 ) & ⋯ & h ( N - ( L - 2 ) ) & h ( N ( L - 1 ) ) \\ & & & & ⋮ & ⋮ \\ & & & & h ( N - 1 ) & h ( N - 2 ) \\ & & & & & h ( N - 1 )\end{matrix} ] ,$$

where h is a time function and has a length being a positive integer N, and the symbol vₙ represents a noise vector.

Concluded from the above definitions, “minimizing an expected value of a difference between an equalized signal \hat{x}(n−δ) and the original signal x(n−δ)” can be mathematically expressed as:

min E{|(n−δ)−(yₙf−\tilde{x}ₙb)|²} (3)

Equation (3) can further be rewritten as:

$${min}_{w} E \{ {\vert x ( n - δ ) - {\underbrace{[ {y}_{n} - {\tilde{x}}_{n} ]}}_{u} {\underbrace{[ \begin{matrix}f \\ b\end{matrix} ]}}_{w} \vert}^{2} \} \qquad ( 4 )$$

Equation (4) can be solved by a Wiener filter mathematical model:

wₒₚₜ=Rᵤ⁻¹R_{ux(n-δ)} (5)

In equation (5),

$${R}_{u} = E \{ {u}^{*} u \} = E \{ [ \begin{matrix}{y}_{n}^{*} \\ - {\tilde{x}}_{n}^{*}\end{matrix} ] [ \begin{matrix}{y}_{n}^{*} & - {\tilde{x}}_{n}^{*}\end{matrix} ] \} = [ \begin{matrix}{R}_{y} & - {R}_{y \tilde{x}} \\ - {R}_{\tilde{x} y} & {R}_{\tilde{x}}\end{matrix} ] and$$

$${R}_{ux ( n - δ )} = E \{ {u}^{*} x ( n - δ ) \} = E \{ [ \begin{matrix}{y}_{n}^{*} \\ - {\tilde{x}}_{n}^{*}\end{matrix} ] x ( n - δ ) \} = [ \begin{matrix}{R}_{yx ( n - δ )} \\ - {R}_{\tilde{x} x ( n - δ )}\end{matrix} ] .$$

It is known that a matrix inversion lemma is:

$$\begin{matrix}{[ \begin{matrix}A & B \\ C & D\end{matrix} ]}^{- 1} = [ \begin{matrix}{A}^{- 1} & 0 \\ 0 & 0\end{matrix} ] + [ \begin{matrix}- {A}^{- 1} B \\ I\end{matrix} ] {Δ}_{A}^{- 1} [ \begin{matrix}- {CA}^{- 1} & I\end{matrix} ] , where \\ {Δ}_{A}^{- 1} = {( D - {CA}^{- 1} B )}^{- 1} = {D}^{- 1} + {D}^{- 1} C {Δ}_{D}^{- 1} {BD}^{- 1} and & ( 6 ) \\ {[ \begin{matrix}A & B \\ C & D\end{matrix} ]}^{- 1} = [ \begin{matrix}0 & 0 \\ 0 & {D}^{- 1}\end{matrix} ] + [ \begin{matrix}I \\ - {D}^{- 1} C\end{matrix} ] {Δ}_{D}^{- 1} [ \begin{matrix}I & - {BD}^{- 1}\end{matrix} ] , where \\ {Δ}_{D}^{- 1} = {( A - {BD}^{- 1} C )}^{- 1} = {A}^{- 1} + {A}^{- 1} B {Δ}_{A}^{- 1} {CA}^{- 1} . & ( 7 )\end{matrix}$$

By applying the matrix inversion lemma to equation (5), it is deduced that:

$${w}_{opt} = [ \begin{matrix}{I}_{L \times L} \\ {[ {H}_{2} ]}_{M \times L}\end{matrix} {{( {σ}_{v}^{2} {I}_{L} + {\underbrace{{H}_{1}^{*} {H}_{1}}}_{L \times L} + {\underbrace{{H}_{3}^{*} {H}_{3}}}_{L \times L} )}^{- 1} [ {h}^{*} ]}_{L \times 1} = \\ [ \begin{matrix}{f}_{opt} \\ {b}_{opt}\end{matrix} ] , where \\ H = {[ \begin{matrix}{[ {H}_{1} ]}_{( δ + 1 ) \times L} \\ {[ {H}_{2} ]}_{M \times L} \\ {[ {H}_{3} ]}_{( N + L - 2 - δ - M ) \times L}\end{matrix} ]}_{( N + L - 1 ) \times L} , and \\ h = H ( δ + 1 , : ) = {[ \begin{matrix}{{\underbrace{[ h ( δ ) . . . h ( 0 ) ]}}_{\underbrace{{h}_{δ}}}}_{1 \times ( δ + 1 )} & {0}_{1 \times ( L - δ - 1 )}\end{matrix} ]}_{1 \times L} . \qquad ( 8 )$$

After simplification, equation (8) can be rewritten as:

$${w}_{opt} = {[ \begin{matrix}{I}_{L \times L} \\ {[ {H}_{2} ]}_{M \times L}\end{matrix} ] [ {σ}_{v}^{2} {I}_{δ + 1} + {[ {H}_{δ}^{*} {H}_{δ} ]}_{( δ + 1 ) \times ( δ + 1 )} ]}^{- 1} {h}_{δ}^{*} = [ \begin{matrix}{f}_{opt} \\ {b}_{opt}\end{matrix} ] , where {h}_{δ} = {[ h ( δ ) . . . h ( 0 ) ]}_{1 \times ( δ + 1 )} , and \\ {H}_{δ} = {[ \begin{matrix}h ( 0 ) & & & & \\ h ( 1 ) & h ( 0 ) & & & \\ h ( 2 ) & h ( 1 ) & h ( 0 ) & & \\ ⋮ & ⋮ & ⋮ & ⋱ & \\ h ( δ ) & h ( δ - 1 ) & h ( δ - 2 ) & ⋯ & h ( 0 )\end{matrix} ]}_{( δ + 1 ) \times ( δ + 1 )} ≡ {[ \begin{matrix}{h}_{0} \\ {h}_{1} \\ {h}_{0} \\ ⋮ \\ {h}_{0}\end{matrix} ]}_{( δ + 1 ) \times ( δ + 1 )} . \qquad ( 9 )$$

Concluded from the above deduction, the coefficient calculation circuit 120 can determine the Weiner solution of equation (4) according to:

$$\{ \begin{matrix}{f}_{opt} = {[ {σ}_{v}^{2} {I}_{δ + 1} + {[ {H}_{δ}^{*} {H}_{δ} ]}_{( δ + 1 ) \times ( δ + 1 )} ]}^{- 1} {h}_{δ}^{*} \\ {b}_{opt} = {[ {H}_{2} ]}_{M \times L} {f}_{opt}\end{matrix} \qquad ( 10 )$$

If the coefficient calculation circuit 120 alternatively adopts a zero forcing mathematical model to solve equation (4), a result similar to equation (10) is obtained:

$$\{ \begin{matrix}{f}_{opt} = {[ {H}_{δ}^{*} {H}_{δ} ]}_{( δ + 1 ) \times ( δ + 1 )}^{- 1} {h}_{δ}^{*} \\ {b}_{opt} = {[ {H}_{2} ]}_{M \times L} {f}_{opt}\end{matrix} \qquad ( 11 )$$

Theoretically, the more capable of reflecting actual channel conditions the estimated channel impulse response h determined by the channel estimation circuit 110 is, the more ideal the initial values of filter coefficients generated by the coefficient calculation circuit 120 are, also the time-domain decision feedback equalizer 130 converges more quickly. In reality, channel conditions are constantly changing. When the length of the estimated channel impulse response h cannot be predicted, in order to cover all possible channel conditions, the estimation period of the channel estimation circuit 110 is usually designed as very long, so that the estimated channel impulse response h has a wide length N.

However, it is seen from equations (10) and (11) that, when the coefficient calculation circuit 120 calculates the filter coefficient vector fₒₚₜ of the feedforward filter 130A and the filter coefficient vector bₒₚₜ of the feedback filter 130C, the complexity of the calculation process is positively correlated with the lengths of the vectors fₒₚₜ and bₒₚₜ (respectively L and M). In practice, the vector length L is usually designed to be equal to the length N of the estimated channel impulse response, and the vector length M is positively correlated with the length N of the estimated channel impulse response and the vector length L. More specifically, the longer the estimated channel impulse response h is, the larger the matrix H gets. Therefore, the calculation to be performed by the coefficient calculation circuit 120 also becomes more complex. It is understandable that, when it takes more time to generate the initial values of filter coefficients due to the complex coefficient calculation, even if a more ideal calculation result is obtain, the time when the time-domain decision feedback equalizer 130 can start operating stably is delayed.

### SUMMARY OF THE INVENTION

To solve the above issues, the present invention provides a wireless communication system and a signal processing method thereof.

According to an embodiment of the present invention, a wireless communication system includes a channel estimation circuit, a shortening circuit, a time-domain decision feedback equalizer, and a coefficient calculation circuit. The channel estimation circuit generates an estimated channel impulse response according to a received signal. The shortening circuit defines a shortened impulse response from the estimated channel impulse response according to a main energy distribution region of the estimated channel impulse response. The time-domain decision feedback equalizer performs time-domain equalization on the received signal, and includes a feedforward equalizer for filtering the received signal. The coefficient calculation circuit calculates, according to the shortened impulse response, a set of feedforward filter coefficients to be utilized by the feedforward filter.

According to another embodiment of the present invention, a signal processing method applied to a wireless communication system is provided. The signal processing method includes: generating an estimated channel impulse response according to a received signal; slicing a shortened impulse response from the estimated channel impulse response according to a main energy distribution region of the estimated channel impulse response; calculating a set of feedforward coefficients according to the shortened impulse response; and performing time-domain decision feedback equalization on the received signal, wherein the time-domain decision feedback equalization includes a feedforward filter process performed on the received signal by utilizing the set of feedforward filter coefficients.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a schematic diagram of a wireless receiver including a time-domain decision feedback equalizer;

FIG. 2 (prior art) is a signal model corresponding to a time-domain decision feedback equalizer;

FIG. 3 is a function block diagram of a wireless communication system according to an embodiment of the present invention;

FIG. 4(A) is an example of an estimated channel impulse response;

FIG. 4(B) is a detailed implementation example of a shortening circuit according to an embodiment of the present invention;

FIG. 4(C) illustrates how to define a main energy distribution region of an estimated channel impulse response according to energy peaks;

FIG. 5 is a wireless communication system further including a configuration controller according to an embodiment of the present invention;

FIG. 6(A) is another example of an estimated channel impulse response;

FIG. 6(B) is another detailed implementation example of a shortening circuit according to an embodiment of the present invention; and

FIG. 7 is a flowchart of a signal processing method according to an embodiment of the present invention.

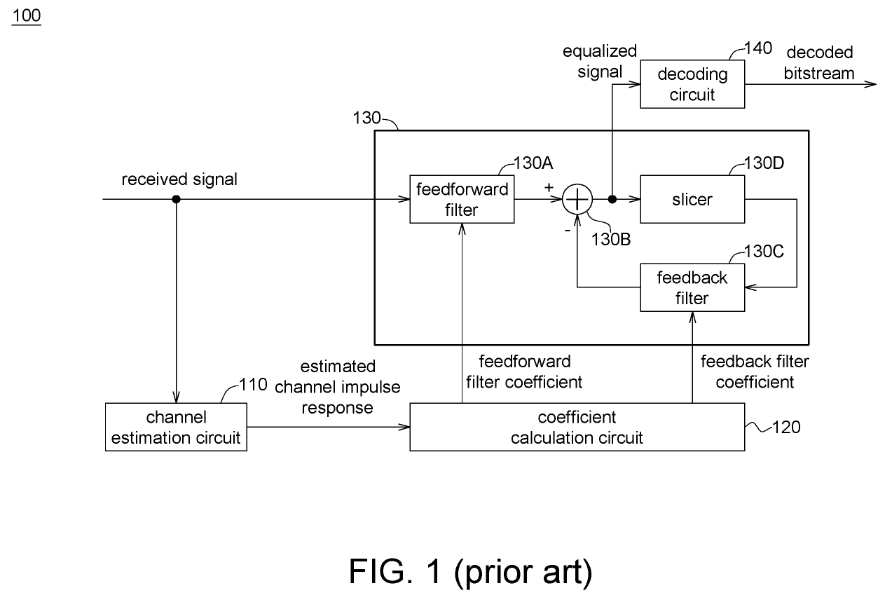

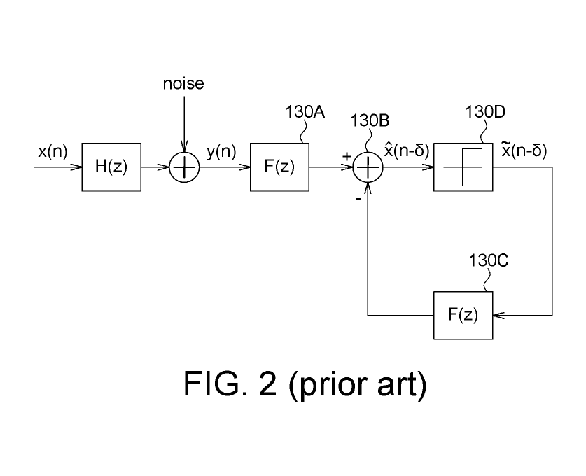

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

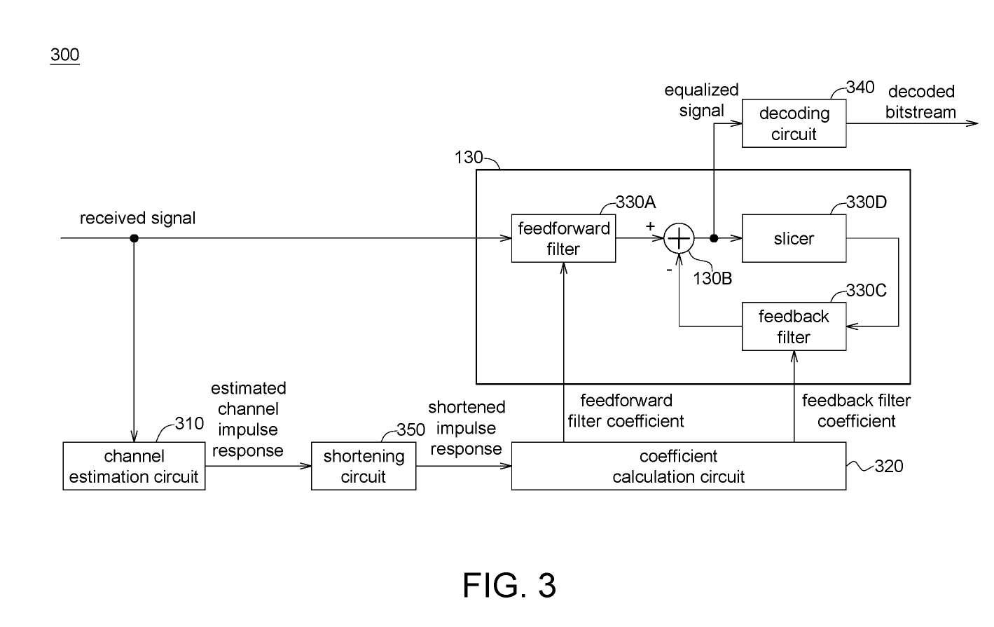

FIG. 3 shows a function block diagram of a wireless communication system 300 according to an embodiment of the present invention. The wireless communication system 300 includes a channel estimation circuit 310, a coefficient calculation circuit 320, a time-domain decision feedback equalizer 330, a decoding circuit 340, and a shortening circuit 350, with associated details given below.

The channel estimation circuit 310 generates an estimated channel impulse response h according to a received signal entering the wireless communication system 300. The time-domain decision feedback equalizer 300 performs time-domain equalization on the received signal, and includes a feedforward filter 330A, an adder 330B, a feedback filter 330C and a slicer 330D. An equalized signal outputted by the time-domain decision feedback equalizer 330 is transmitted to the decoding circuit 340 for decoding to generate a decoded bitstream.

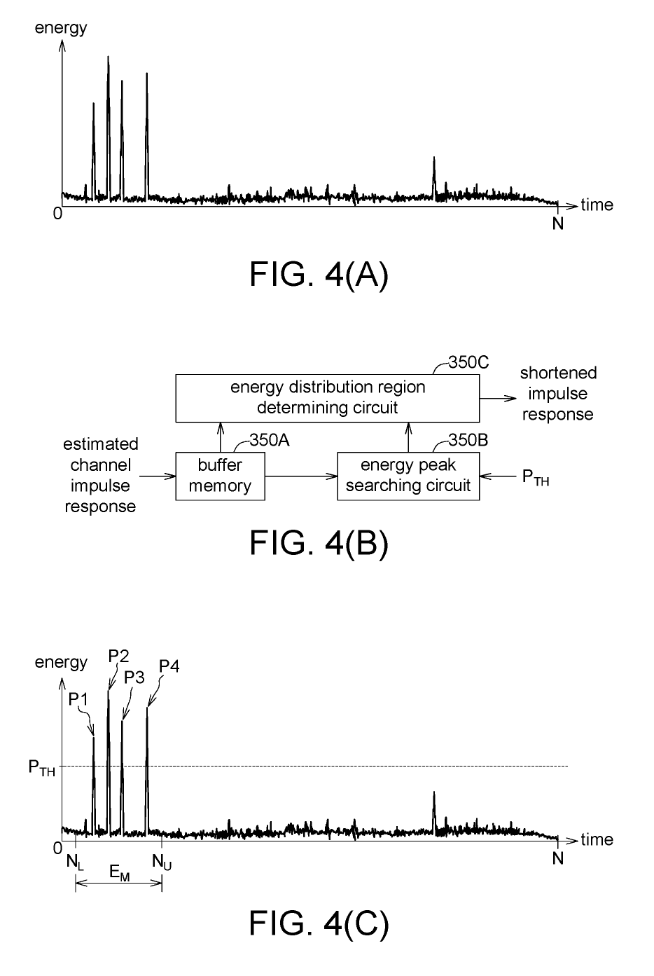

The coefficient calculation circuit 320 calculates a set of feedforward filter coefficients f and a set of feedback filter coefficients b for the feedforward filter 330A and the feedback filter 330C, respectively. Different from the circuit structure of the wireless communication system 100, the shortening circuit 350 is coupled between the channel estimation circuit 310 and the coefficient calculation circuit 320. The shortening circuit 350 defines a main energy distribution region E_{M} for the estimated channel impulse response h, and accordingly slices a part from the estimated channel impulse response h as a shortened impulse response hₛ . FIG. 4(A) shows an example of an estimated channel impulse response h. In FIG. 4(A), the vertical axis represents energy, the horizontal axis represents time, and time length N of the estimated channel impulse response h is a predetermined value determined by the channel estimation circuit 310. As shown in FIG. 4(A), the energy of the estimated channel impulse response h is not evenly distributed, energy peak values usually occur at some time points, while energy values at other time points are noticeably lower than those energy peaks. The shortening circuit 350 selects, from a time range 0 to N, a segment covering most of the energy in the estimated channel impulse response h, wherein the selected segment serves as the main energy distribution region E_{M}. There are many approaches for determining the main energy distribution region EM that can be applied to the shortening circuit 350. Several embodiments are described below.

In one embodiment, the shortening circuit 350 defines the main energy distribution region E_{M} according to positions of the energy peaks. FIG. 4(B) shows a function block diagram of the shortening circuit 350. A buffer memory 350A stores the estimated channel impulse response h generated by the channel estimation circuit 310. For example, the buffer memory 350A can uses multiple registers to store energy values corresponding different time points in the estimated channel impulse response h. The present invention is not limited any particular storage mechanism. The buffer memory 350A may be a volatile or non-volatile memory, e.g., DRAM or flash. A peak energy searching circuit 350B identifies an energy peak greater than a predetermined threshold P_{TH} from the estimated channel impulse response h. Taking the example shown in FIG. 4(C) for instance, the energy peak searching circuit 350B identifies four energy peaks P1 to P4 in total. The energy distribution region determining circuit 350C defines the main energy distribution region EM according to the energy peaks P1 to P4. For example, the energy distribution region determining circuit 350C can define a lower range limit N_{L} of the main energy distribution region E_{M} from the energy peak P1 to the left by a predetermined time length, and define an upper range limit N_{U} from the energy peak P4 to the right by a predetermined time length (with actual values determined by a circuit designer based on experience). The energy distribution region determining circuit 350C then retrieves a part of the estimated channel impulse response h corresponding to the main energy distribution region E_{M} (i.e., the time range N_{L} to N_{U}) from the buffer memory 350A, wherein the retrieved part serves as the shortened impulse response hₛ (i.e., values outside the main energy distribution region E_{M} of the estimated channel impulse response h are not considered). In this embodiment, the shortening circuit 350 does not define in advance the length of the main energy distribution region E_{M}.

In another embodiment, the shortening circuit 350 first calculates total energy of the estimated channel impulse response h, and searches for a continuous time range covering 80% of the total energy from the estimated channel impulse response h to serve as the main energy distribution region E_{M}. In this embodiment, the shortening circuit 350 does not define in advance the length of the main energy distribution region E_{M}, either.

It is seen from FIG. 3 that, the coefficient calculation circuit 320 calculates the feedforward filter coefficient f according to the matrix (to be denoted as H_{S}) formed by the shortened impulse response hₛ (instead of the estimated channel impulse response h generated by the channel estimation circuit 310) generated by the shortening circuit 350. As previously described, whether a Wiener filter or zero forcing mathematical model is used, when the coefficient calculation circuit 320 calculates the feedforward filter coefficient f, the complexity of the calculation process is positively correlated with the length of the estimated channel impulse response h. Apparently, compared to adopting the matrix H formed by the estimated channel impulse response h, the calculation complexity in the coefficient calculation circuit 320 is effectively reduced when the matrix H_{S} generated by the shortened impulse response hₛ is adopted for calculating the feedforward coefficient f. By selecting an appropriate main energy distribution region E_{M}, most part of energy of the estimated channel impulse response h is covered therein, and so the feedforward filter coefficient f calculated according to the matrix H_{S} by the coefficient calculation circuit 320 does not differ much from the ideal value. Further, the effect caused by the difference can be later mitigated by iteration correction of the time-domain decision feedback equalizer 330.

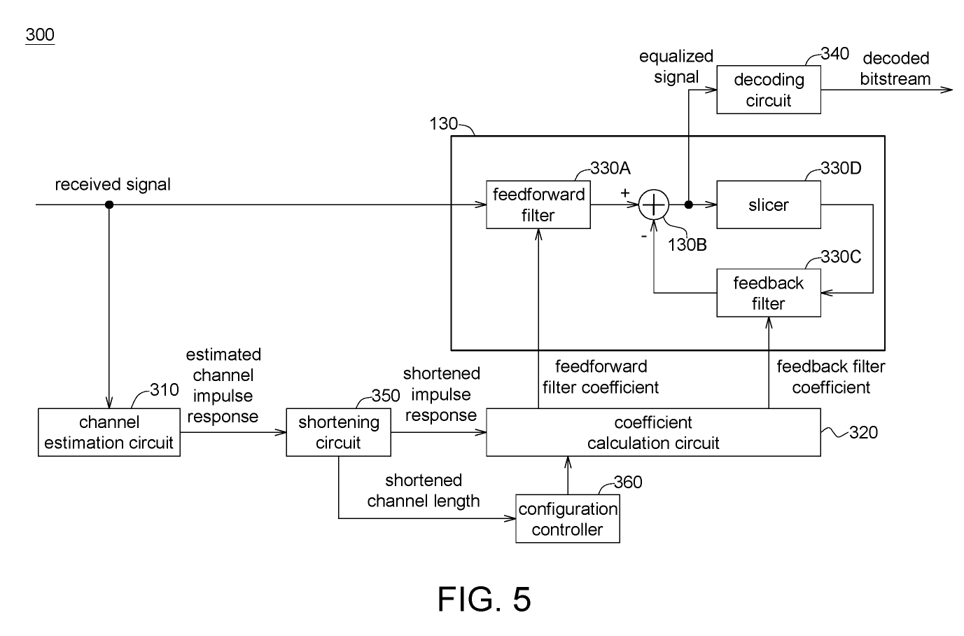

In one embodiment, as shown in FIG. 5, the wireless communication system 300 further includes a configuration controller 360 between the shortening circuit 350 and the coefficient calculation circuit 320. The coefficient calculation circuit 320 can be adaptively configured by the controller 360, rather than performing calculation only based on the shortened impulse response hₛ with predetermined channel length. In this structure, the shortening circuit 350 is capable of determining the length of the main energy distribution region. After the shortening circuit 350 generates the shortened impulse response hₛ, the configuration controller 360 configures the coefficient calculation circuit 320 according to a channel length of the shortened impulse response hₛ.

In one embodiment, in addition to the feedforward filter coefficient f, the coefficient calculation circuit 320 further generates the feedback filter coefficient b according to the matrix H_{S} corresponding to the shortened impulse response hₛ. In such situation, because both of the feedforward coefficient f and the matrix H_{S} have been simplified, calculation complexity that the coefficient calculation circuit 320 performs to calculate the feedback filter coefficient b can be significantly lowered.

In another embodiment, the coefficient calculation circuit 320 uses the matrix H_{S} only for calculating the feedforward filter coefficient f, while uses the matrix H formed by the estimated channel impulse response h to calculate and generate the feedback filter coefficient b. One benefit of the above approach is that, for the feedback filter coefficient b, non-idealness resulted by the shortened impulse response can be reduced. Further, as seen from equation (10) and equation (11), unlike the complicated inverse matrix calculation for generating the feedforward filter coefficient f, the linear calculation for generating the feedback filter coefficient b is much more simple. Thus, even if the matrix H formed by the estimated channel impulse response h is used for generating the feedback filter coefficient b, the coefficient calculation circuit 320 will not process huge amount of calculation.

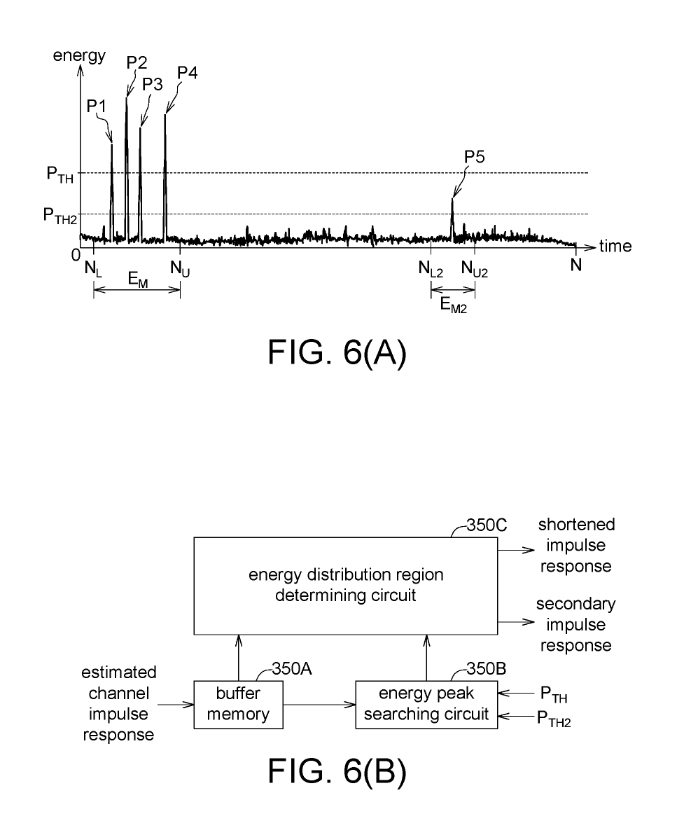

Refer to FIG. 6(A) and FIG. 6(B). In one embodiment, the energy peak searching circuit 350B further refers to another predetermined threshold P_{TH2} to identify energy peaks between the two predetermined thresholds P_{TH} and P_{TH2} from the estimated channel impulse response h. Taking the estimated channel impulse response h in FIG. 6(A) for example, the energy peak searching circuit 350B further identifies an energy peak P5, according to which the energy distribution region determining circuit 350C defines a secondary energy distribution region E_{M2} that does not overlap the main energy distribution region E_{M}. The secondary energy distribution region E_{M2} is regarded as a less important energy concentrated area. For example, the energy distribution region determining circuit 350C can set a lower range limit N_{L2} of the time axis of the secondary energy distribution region E_{M2} from the energy peak P5 to the left by a predetermined time length, and set an upper range limit N_{U2} of the time axis from the energy peak P5 to the right by a the predetermined time length. The energy distribution region determining circuit 350C then retrieves the part of the estimated channel impulse response h corresponding to the secondary energy distribution region E_{M2} (between the time range N_{L2} and N_{U2}) from the buffer memory 350A, and the retrieved part is utilized as a secondary impulse response hₛ₂.

In this embodiment, the shortening circuit 350 provides both of the shortened impulse response hₛ and the secondary impulse response hₛ₂ to the coefficient calculation circuit 320. As previously described, the coefficient calculation circuit 320 performs linearly calculation when generating the feedback filter coefficient b according to equation (10) or equation (11). Thus, the coefficient calculation circuit 320 can calculate two sets of feedback filter coefficients respectively according to the shortened impulse response hₛ and the secondary impulse response h_{s2,} and then superimpose the two sets of feedback filter coefficients to provide a result as the feedback filter coefficient b. Compared to a situation where the feedback filter coefficient b is generated only according to the shortened impulse response hₛ , by having the coefficient calculation circuit 320 further take into account the secondary impulse response h_{s2,} the feedback filter coefficient b can be more ideal without incurring too much calculation loading.

For one person skilled in the art, it can be appreciated that, similar to the main energy distribution region E_{M}, the shortening circuit 350 is not limited to defining the secondary energy distribution region E_{M2} according to positions of the energy peaks. For example, the shortening circuit 350 can calculate the remaining energy of the estimated channel impulse response h outside the main energy distribution region E_{M} so as to determine a continuous time range that covers 80% of the remaining energy but does not overlap the main energy distribution region E_{M} from the estimated channel impulse response h by using an integrator, and utilize this continuous time range as the secondary energy distribution region E_{M2}.

In practice, the shortening circuit 350 may be implemented by various control and processing platforms, including fixed and programmable logic circuits, e.g., a programmable logic gate array, an application-specific integrated circuit, a microcontroller, a microprocessor and a digital signal processor. Further, these two circuits may also be designed to complete respective tasks through executing a processor command stored in a memory. One person skilled in the art can understand that there are many circuit configurations and devices that can achieve the concept of the present invention without departing from the spirit of the present invention.

It should be noted that, the feedforward filter coefficient f and the feedback filter coefficient b generated by the coefficient calculation circuit 320 are not limited to being used as initial values of filter coefficients of the time-domain decision feedback equalizer 330. After the time-domain decision feedback equalizer 330 starts operating stably, the channel estimation circuit 310 can periodically generate a new estimated channel impulse response h, the shortening circuit 350 is controlled to periodically generate a shortened impulse response hₛ, and the coefficient calculation circuit 320 is caused to generate a new feedforward filter coefficient f and a new feedback filter coefficient b for the time-domain decision feedback equalizer 330.

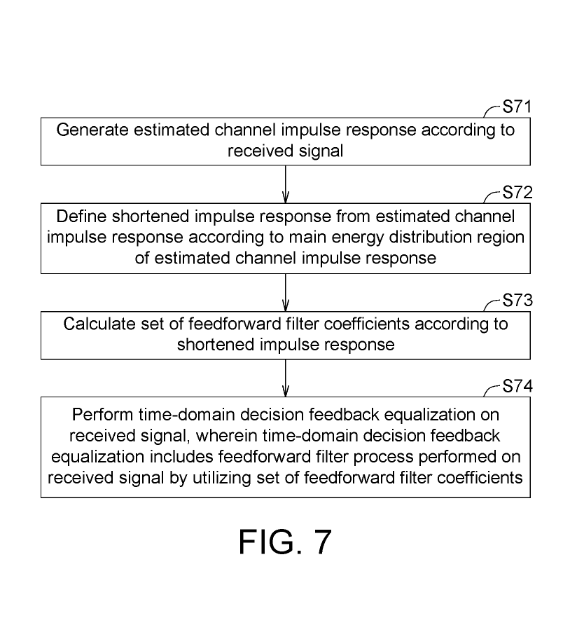

FIG. 7 shows a flowchart of a signal processing method applied to a wireless communication system according to another embodiment of the present invention. In step S71, an estimated channel impulse response is generated according to a received signal. In step S72, according to a main energy distribution region of the estimated channel impulse response, a shortened impulse response is defined from the estimated channel impulse response. In step S73, a set of feedforward filter coefficients are calculated according to the shortened impulse response. In step S74, time-domain decision feedback equalization is performed on the received signal, wherein the time-domain decision feedback equalization includes a feedforward filter process performed on the received signal by utilizing the set of feedforward filter coefficients.

One person skilled in the art can understand that, the operation variations in the description associated with the wireless communication system 300 are applicable to the signal processing method in FIG. 7, and such repeated details are omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures. It should be noted that, the mathematical expressions in the disclosure are for illustrating principles and logics associated with the embodiments of the present invention. Unless otherwise specified, these mathematical expressions do not levy limitations to the present invention. One person skilled in the art can understand that, there are various other technologies capable of realizing the physical forms corresponding to these mathematical expressions.

What is claimed is:

A wireless communication system, comprising:
a channel estimation circuit, generating an estimated channel impulse response according to a received signal
a shortening circuit, defining a main energy distribution region of the estimated channel impulse response, and defining a shortened impulse response from the estimated channel impulse response according to the main energy distribution region;
a time-domain decision feedback equalizer, performing time-domain equalization on the received signal, comprising a feedforward filter for filtering the received signal; and
a coefficient calculation circuit, calculating, according to the shortened impulse response, a set of feedforward filter coefficients to be utilized by the feedforward filter.

2. The wireless communication system according to claim 1, wherein the coefficient calculation circuit is adaptively configured instead of performing calculation according to the shortened impulse response having a predetermined channel length; the wireless communication system further comprising:
a configuration controller, coupled between the shortening circuit and the coefficient calculation circuit, configuring the coefficient calculation circuit according to a channel length corresponding to the shortened impulse response.

3. The wireless communication system according to claim 1, wherein the time-domain feedback equalizer comprises a feedback filter, and the coefficient calculation circuit calculates, according to the estimated channel impulse response, a set of feedback filter coefficients for the feedback filter.

4. The wireless communication system according to claim 1, wherein the time-domain decision feedback equalizer comprises a feedback filter, and the coefficient calculation circuit further calculates, according to the shortened impulse response, a set of feedback filter coefficients for the feedback filter.

5. The wireless communication system according to claim 4, wherein the shortening circuit further defines, from the estimated impulse channel response, a secondary energy distribution region different from the main energy distribution region, and defines a secondary impulse response according to the secondary energy distribution region; the coefficient calculation circuit calculates the set of feedback filter coefficients according to both the shortened impulse response and the secondary impulse response.

6. A signal processing method for a wireless communication system, comprising:
a) generating an estimated channel impulse response according to a received signal;
b) defining a main energy distribution region of the estimated channel impulse response, and defining a shortened impulse response from the estimated channel impulse response according to the main energy distribution region;
c) calculating a set of feedforward filter coefficients according to the shortened impulse response; and
d) performing time-domain decision feedback equalization, comprising performing a feedforward filtering process, applying the set of feedforward filter coefficients, on the received signal.

7. The signal processing method according to claim 6, wherein performing the time-domain decision feedback equalization further comprises performing a feedback filter process; the signal processing method further comprising:
e) calculating, according to the estimated channel impulse response, a set of feedback filter coefficients for the feedback filter process.

8. The signal processing method according to claim 6, wherein time-domain decision feedback equalization further comprises performing a feedback filter process; the signal processing method further comprising:
e) calculating, according to the shortened impulse response, a set of feedback filter coefficients for the feedback filter process.

9. The signal processing method according to claim 8, wherein time-domain decision feedback equalization further comprises performing a feedback filter process; the signal processing method further comprising:
defining a secondary impulse response from the estimated channel impulse response according to a secondary energy distribution region of the estimated channel impulse response; and
calculating the set of feedback filter coefficients according to the shortened impulse response and the secondary impulse response.
